(19) United States
(12) Patent Application Publication
(10) Pub. No.: US 2002/0010862 A1
(43) Pub. Date: Jan. 24, 2002

(54) Biometric authentication system sharing template data among enterprises

(76) Inventor: Kazuaki Ebara, Gunma (JP)

Correspondence Address: Venable, P.O. Box 34385, Washington, DC, 20043-9998, US

(21) Appl. No.: 09/855,714

(22) Filed: May 16, 2001

(30) Foreign Application Priority Data
May 23, 2000 (JP) 150720/00

(51) Int. Cl. H04L 9/32

(52) U.S. Cl. 713/186; 713/200

(57) ABSTRACT

A biometric authentication system includes multiple enterprise systems linked by a communication network. Each enterprise system stores biometric template data of registered users and authenticates the users by comparing biometric authentication data with the template data. A user registered with a first enterprise system can become registered with a second enterprise system by submitting biometric authentication data to the second enterprise system. The second enterprise system obtains the user's template data from the first enterprise system through the communication network, and stores the template data for future use.

### BACKGROUND OF THE INVENTION

The present invention relates to a biometric authentication system that uses a biometric characteristic to verify a person's identity.

Financial and other institutions that need to verify the identity of their users have generally relied on means such as magnetic cards and personal identification numbers. Since cards can be stolen and numbers can be found out, however, biometric authentication systems that use biometric means such as fingerprints, voiceprints, facial characteristics, and iris patterns have begun to appear.

A user of a biometric authentication system is first registered by a system operator. The system operator obtains the individual's name and other relevant information, such as an account identification number, checks the individual's identity, then uses special equipment that acquires and digitizes a biometric characteristic of the individual and extracts features from the digitized information. The system operator checks the quality of the acquired information and selects information of sufficient quality for use in future authentication. The selected information is entered as a template in a dictionary, which is stored in a database. Thereafter, when the individual uses the system, the individual's biometric information is obtained again and compared with the stored template to authenticate the individual.

One problem in this type of system is the need to install special equipment for acquiring biometric information and creating templates at each site that registers new users. For a person wishing to become a user, the problem is the need to go to a location where such equipment is installed. Another problem is that it is not easy to tell when the quality of the acquired biometric information is adequate for template use, so a highly trained system operator is needed at each location, and the registration process tends to take time. As biometric authentication systems become widespread, these problems will have to be faced repeatedly by the systems and individuals involved.

### SUMMARY OF THE INVENTION

An object of the present invention is to enable a person to become registered with a biometric authentication system more easily.

Another object of the invention is to enable a biometric authentication system to register users more easily.

The invented biometric authentication system comprises a first enterprise system and a second enterprise system interconnected by a communication network. The first enterprise system includes a registration apparatus, a first authentication apparatus, and a first database server apparatus. The second enterprise system includes a second authentication apparatus and a second database server apparatus.

The registration apparatus acquires a user's biometric information, extracts features from the acquired information, and converts the features to template data,

The first and second authentication apparatuses acquire a user's biometric information, extract features from the acquired information, and convert the features to authentication data.

The first and second database server apparatuses receive and store template data, receive authentication data, and authenticate users by comparing the authentication data with the template data. The first database server apparatus receives template data from the registration apparatus. The second database server apparatus receives template data from the first database server apparatus through the communication network.

A user who has been registered with the first enterprise system by use of the registration apparatus can become registered with the second enterprise system simply by providing authentication data to the second enterprise system through the second authentication apparatus.

The second enterprise system can register users simply by acquiring their template data from the first enterprise system, without having to provide or operate a registration apparatus.

The second enterprise system may have a simplified registration apparatus that acquires a user's biometric information, extracts features from the acquired information, and converts the features to authentication data. Authentication data obtained in this way are sent to the first enterprise system, where the first database server apparatus compares the authentication data with its stored template data to authenticate the user before sending the template data to the second database server apparatus, thereby protecting the user's privacy. Authentication data obtained from the second authentication apparatus are used to authenticate users whose template data are already stored in the second database server apparatus.

### BRIEF DESCRIPTION OF THE DRAWINGS

In the attached drawings:

FIG. 1 is a block diagram of a first embodiment of the invention;

FIG. 2 is a block diagram of a second embodiment;

FIG. 3 is a block diagram of a third embodiment;

FIG. 4 is a block diagram of a fourth embodiment;

FIG. 5 is a block diagram of a fifth embodiment;

FIG. 6 is a block diagram of a sixth embodiment; and

FIG. 7 is a block diagram of a seventh embodiment.

### DETAILED DESCRIPTION OF THE INVENTION

Biometric authentication systems embodying the invention will be described with reference to the attached drawings, in which like parts are indicated by like reference characters.

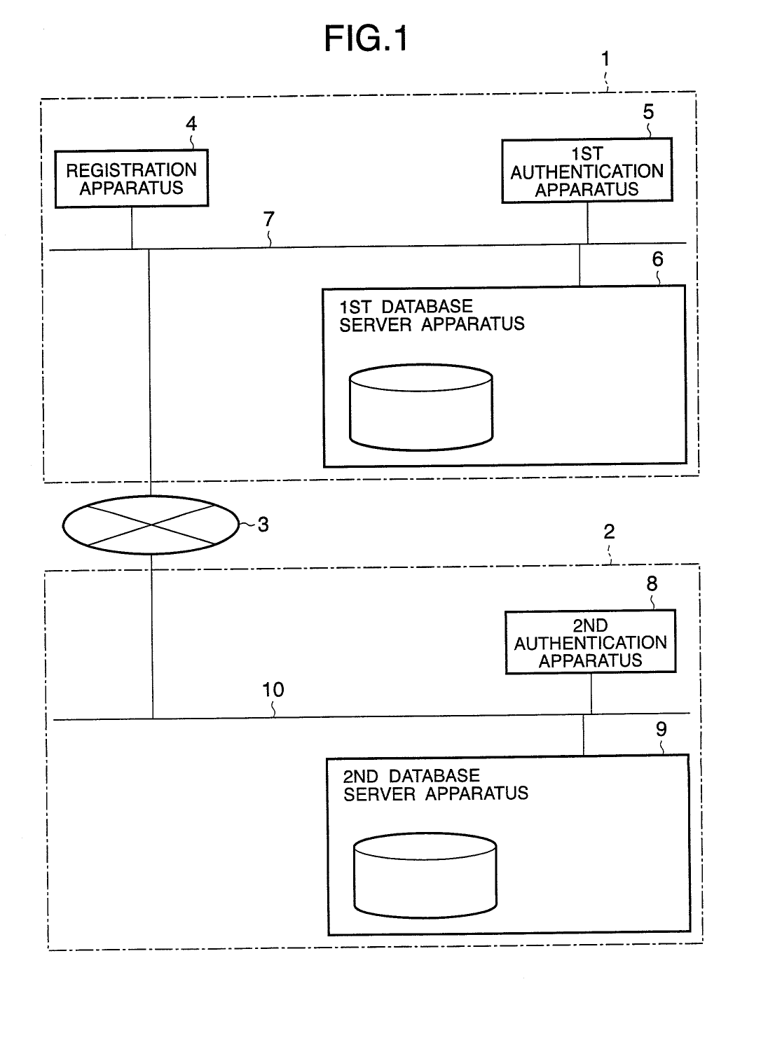

The first embodiment, shown in FIG. 1, is a biometric authentication system comprising a first enterprise system 1 and a second enterprise system 2 linked by a communication network 3. The first enterprise system 1 comprises a registration apparatus 4, a first authentication-apparatus 5, a first database server apparatus 6, and a first local area network (LAN) 7. The second enterprise system 2 comprises a second authentication apparatus 8, a second database server apparatus 9, and a second LAN 10.

The registration apparatus 4 acquires a user's biometric information, extracts features therefrom, and converts the features to template data, performing these operations during registration of the user.

The first authentication apparatus 5 acquires the user's biometric information, extracts features therefrom, and converts the features to authentication data, performing these operations during authentication of the user. The first authentication apparatus 5 also has facilities such as a keyboard or magnetic card reader, by which the user enters identifying information.

The first database server apparatus 6 receives the template data generated by the registration apparatus 4, and stores and manages the template data in an internal dictionary (not visible). During authentication, the first database server apparatus 6 receives authentication data from the first authentication apparatus 5, and authenticates the user by comparing the authentication data with the stored template data.

The first LAN 7 interconnects the registration apparatus 4, the first authentication apparatus 5, and the first database server apparatus 6. An existing general-purpose enterprise LAN may be used as the first LAN 7.

The second authentication apparatus 8 acquires a user's biometric information, extracts features therefrom, and converts the features to authentication data, performing these operations both during registration and during authentication. The second authentication apparatus 8 also has facilities such as a keyboard or magnetic card reader, by which the user enters identifying information.

The second database server apparatus 9 receives authentication data from the second authentication apparatus 8, receives corresponding template data from the first database server apparatus 6, compares the authentication data with the template data to authenticate the user, and if the authentication succeeds, stores the template data in an internal dictionary (not visible).

The second LAN 10 interconnects the second authentication apparatus 8 and second database server apparatus 9. An existing general-purpose enterprise LAN may be used as the second LAN 10.

The communication network 3 interconnects the first enterprise system 1 and second enterprise system 2 and possibly other enterprise systems. The communication network 3 may be an existing wide area network (WAN) that is also used for general communication purposes.

Although only one second enterprise system 2 is shown in FIG. 1, the biometric authentication system preferably includes more than one second enterprise system. The effect of the invention increases as the number of second enterprise systems increases.

Although the first enterprise system 1 and second enterprise system 2 are shown in FIG. 1 as having only one data base server, one authentication apparatus, and (for the first enterprise system) one registration apparatus each, the entire system may include, for example, one data base server per enterprise system, one registration apparatus installed in each of several offices of the first enterprise, and a large number of authentication apparatuses installed in user terminal equipment operated by the first and second enterprises.

Next, the operation of the first embodiment will be described. As a specific example, it will be assumed that the enterprises are banks, the first enterprise system 1 belonging to a bank A and the second enterprise system 2 belonging to a bank B, and that the biometric authentication system is used to authenticate users of automatic teller machines (ATMs) operated by the banks. It will also be assumed that iris patterns are used as biometric information.

When a user opens an account at bank A, the user's iris pattern is acquired by the registration apparatus 4 in the first enterprise system 1. Features are extracted from the iris pattern and converted to template data, which are stored (and managed) in the first database server apparatus 6. This process involves a trained operator of the registration apparatus 4. The user also fills out the usual application forms for opening a bank account.

Having established an account, the user may use an ATM to conduct a transaction with bank A. In this case the user inserts a magnetic card bearing a user identification number, for example, into the first authentication apparatus 5, which is built into the ATM. Instead of using a card, the user may enter the identification number or other identifying information on a keyboard. Next, the user has his or her iris pattern authenticated by the first authentication apparatus 5. For this purpose, the first authentication apparatus 5 acquires the user's iris pattern, extracts features from the pattern, and converts the features to authentication data. The first authentication apparatus 5 sends the authentication data and user identification number (or other identifying information) to the first database server apparatus 6.

The first database server apparatus 6 uses the identifying information to retrieve the user's stored template data from the internal dictionary, compares the authentication data with the template data, finds that they match, and thereby authenticates the user, who is now permitted to use the ATM.

Although the user's iris pattern has not yet been registered with bank B, the first embodiment enables the user to become registered with bank B by a simple procedure. When the second enterprise system 2 requests the user's iris pattern, the user inserts the above-mentioned magnetic card into the second authentication apparatus 8, or enters identifying information on a keyboard. The second authentication apparatus 8 acquires the user's iris pattern, extracts features, and converts them to authentication data. The second database server apparatus 9 receives the user's identifying information and authentication data and sends the identifying information through the communication network 3 to the first database server apparatus 6. The first database server apparatus 6 uses the identifying information to retrieve the user's template data from its internal dictionary, and sends the template data back to the second database server apparatus 9. The second database server apparatus 9 compares the authentication received from the second authentication apparatus 8 with the template data received from the first database server apparatus 6. If the data match, the second database server apparatus 9 stores the template data in its own internal dictionary, thereby registering the user. If the user is attempting to use an ATM operated by bank B, the second database server apparatus 9 also gives permission for use of the ATM.

Once a user's iris pattern (or other biometric information) has been registered with the first enterprise, the first embodiment makes it very easy for the second enterprise to register the same user's iris pattern. The user only has to respond to a request for iris-pattern authentication from the second enterprise. The user does not have to go to a second-enterprise location equipped with a registration apparatus, and no trained operator is required.

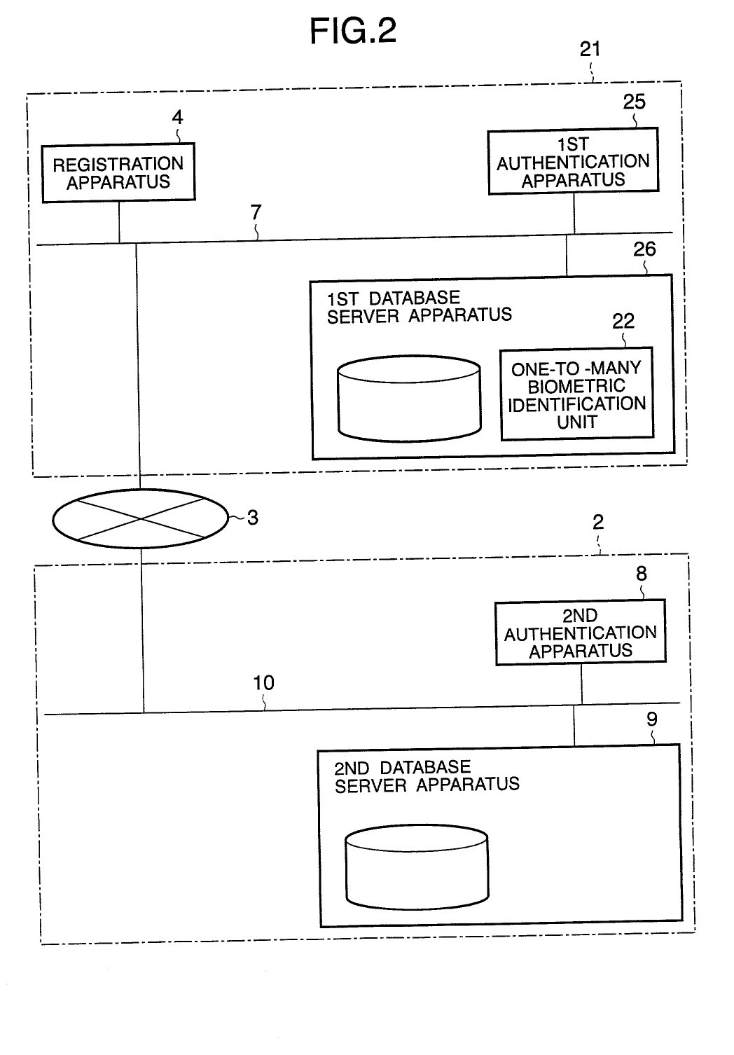

The second embodiment has the configuration shown in FIG. 2, comprising a first enterprise system 21 and a second enterprise system 2 linked by a communication network 3. The first enterprise system 21 comprises a registration apparatus 4, a first authentication apparatus 25, a first database server apparatus 26, and a first LAN 7. The second enterprise system 2 comprises a second authentication apparatus 8, a second database server apparatus 9, and a second LAN 10.

During authentication, the first authentication apparatus 25 acquires the user's biometric information, extracts features therefrom, and converts the features to authentication data.

The first database server apparatus 26 stores and manages the template data received from the registration apparatus 4 in an internal dictionary. During authentication, when the first database server apparatus 26 receives authentication data from the first authentication apparatus 25, and compares the authentication data with the template data to authenticate the user. The first database server apparatus 26 includes a one-to-many biometric identification unit 22 that performs a one-to-many comparison between the authentication data and all of the template data stored and managed in the internal dictionary, and finds the template data matching the authentication data.

The other elements of the second embodiment are identical to the corresponding elements of the first embodiment.

The operation of the second embodiment will be described under the same assumptions as in the first embodiment, namely that banks A and B use the biometric authentication system to authenticate ATM users, bank A operating the first enterprise system 21 and bank B operating the second enterprise system 2.

When a user opens an account at bank A, the same procedure as in the first embodiment is followed to acquire the user's iris pattern and register it in the internal dictionary of the first database server apparatus 26.

When the user uses an ATM operated by bank A, the first authentication apparatus 25 is used to authenticate the user. The first authentication apparatus 25 acquires the user's iris pattern, extracts features, and converts them to authentication data. The first database server apparatus 26 receives the authentication data from the first authentication apparatus 25. The one-to-many biometric identification unit 22 in the first database server apparatus 26 compares the received authentication with all of the template data stored and managed in the internal dictionary of the first database server apparatus 26. If the one-to-many biometric identification unit 22 finds corresponding template data (template data matching the authentication data), the user is permitted to use the ATM.

The user's iris pattern can also be registered with bank B by a simple procedure, in which the second enterprise system 2 only requests the user's iris pattern. The user uses the second authentication apparatus 8 to perform iris-pattern authentication. The second authentication apparatus 8 acquires the user's iris pattern, extracts features, and converts them to authentication data. The second database server apparatus 9 receives the authentication data from the second authentication apparatus 8, and sends the authentication data through the communication network 3 to the first database server apparatus 26. The one-to-many biometric identification unit 22 compares the received authentication data with all of the template data stored in the first database server apparatus 26. If the one-to-many biometric identification unit 22 finds corresponding template data, the first database server apparatus 26 sends the corresponding template data through the communication network 3 to the second database server apparatus 9. The second database server apparatus 9 stores the template data in its own internal dictionary. The user has then been authenticated and registered with the second enterprise system 2, and may proceed to use an ATM operated by bank B.

The second embodiment provides the same effects as the first embodiment, but is easier to use, because the user does not have to enter a user identification number or insert a magnetic card during the authentication process.

In a variation of the second embodiment, the second authentication apparatus 8 in the second enterprise system 2 is not identical to the second authentication apparatus 8 in the first embodiment, but is similar to the first authentication apparatus 25, not having a device such as a magnetic card reader or keyboard for the entry of identification information.

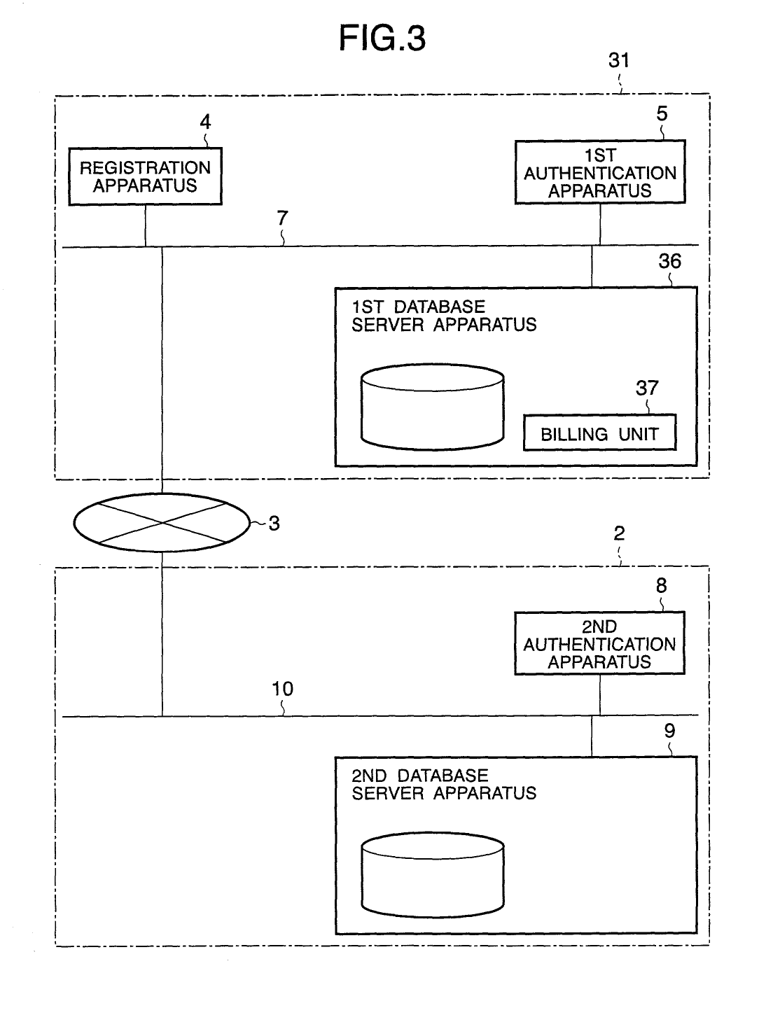

A third embodiment has the configuration shown in FIG. 3, comprising a first enterprise system 31, a second enterprise system 2, and a communication network 3 interconnecting the first enterprise system 31 and second enterprise system 2. The first enterprise system 31 comprises a registration apparatus 4, a first authentication apparatus 5, a first database server apparatus 36, and a first LAN 7. The second enterprise system 2 comprises a second authentication apparatus 8, a second database server apparatus 9, and a second LAN 10.

The first database server apparatus 36 stores and manages template data received from the registration apparatus 4 in an internal dictionary. During authentication, the first database server apparatus 36 compares authentication received from the first authentication apparatus 5 with the stored template data. The first database server apparatus 36 also includes a billing unit 37. When the first database server apparatus 36 is sent identification data from the second database server apparatus 9 and is requested to send back corresponding template data, the billing unit 37 charges the second enterprise system 2 a fee for this service.

The other elements of the third embodiment are identical to the corresponding elements of the first embodiment.

The third embodiment operates in the same way as the first embodiment, except that when template data are transferred from the first database server apparatus 36 to the second database server apparatus 9 in order to register a user's iris pattern with the second enterprise system 2, bank B is billed for this service.

The third embodiment provides the same effects as the first embodiment, with the additional effect when template data are transferred from a first enterprise to a second enterprise, the first enterprise can receive a fee for the service provided to the second enterprise.

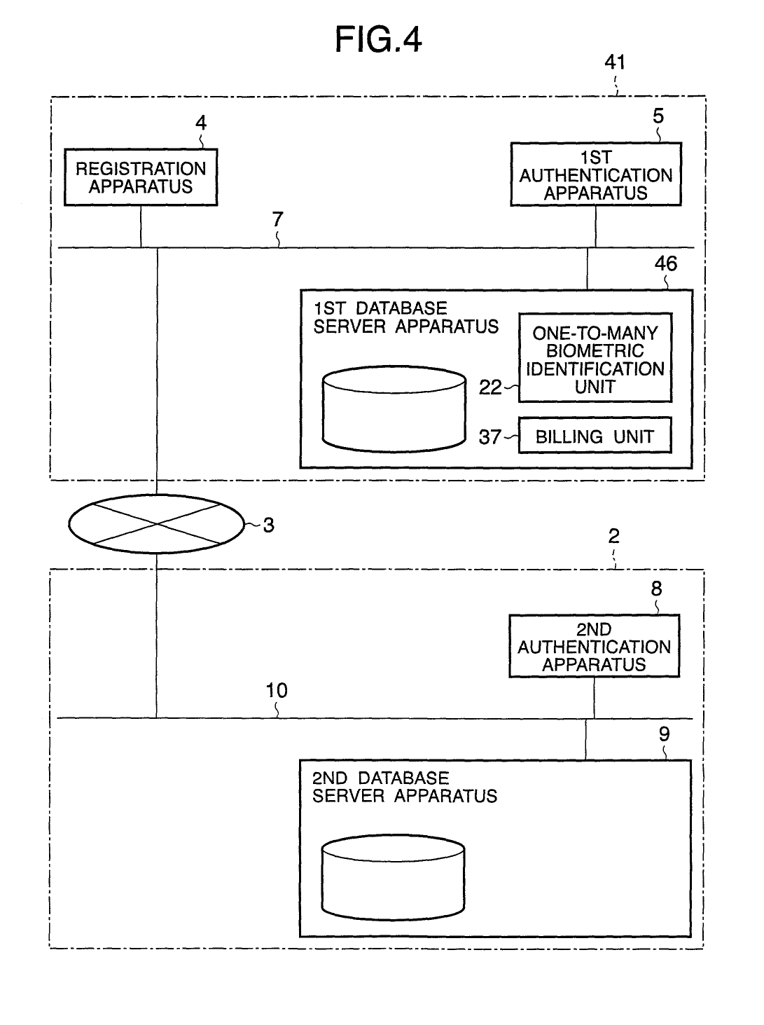

A fourth embodiment has the configuration shown in FIG. 4, comprising a first enterprise system 41 and a second enterprise system 2 interconnected by a communication network 3. The first enterprise system 41 comprises a registration apparatus 4, a first authentication apparatus 5, a first database server apparatus 46, and a first LAN 7. The second enterprise system 2 comprises a second authentication apparatus 8, a second database server apparatus 9, and a second LAN 10.

The first database server apparatus 46 stores and manages template data received from the registration apparatus 4 in an internal dictionary. During authentication, when the first database server apparatus 46 receives authentication data from the first authentication apparatus 5, the first database server apparatus 46 compares the authentication data with the template data to authenticate the user. The first database server apparatus 46 includes a one-to-many biometric identification unit 22 that performs a one-to-many comparison between the authentication data and all of the template data stored and managed in the internal dictionary, and finds the template data matching the authentication data. The first database server apparatus 46 also includes a billing unit 37. The first database server apparatus 46 may be sent authentication data from the second database server apparatus 9 and requested to send back corresponding template data, in which case the billing unit 37 charges the second enterprise system 2 a fee for this service.

The other elements of the fourth embodiment are identical to the corresponding elements of the first embodiment.

The fourth embodiment operates as described in the second and third embodiments. A repeated description will be omitted.

The fourth embodiment provides the same effects as the first embodiment, with the additional effects described in the second and third embodiments. Users can be authenticated without having to insert a magnetic card or enter an identification number, and when template data are transferred from a first enterprise to a second enterprise, the first enterprise can bill the second enterprise for the service rendered.

In a variation of the fourth embodiment, the first authentication apparatus 5 and second authentication apparatus 8 are not identical to the corresponding elements in the first embodiment, but are similar to the first authentication apparatus 25 in the second embodiment, not having a device such as a magnetic card reader or keyboard for the entry of user identification information.

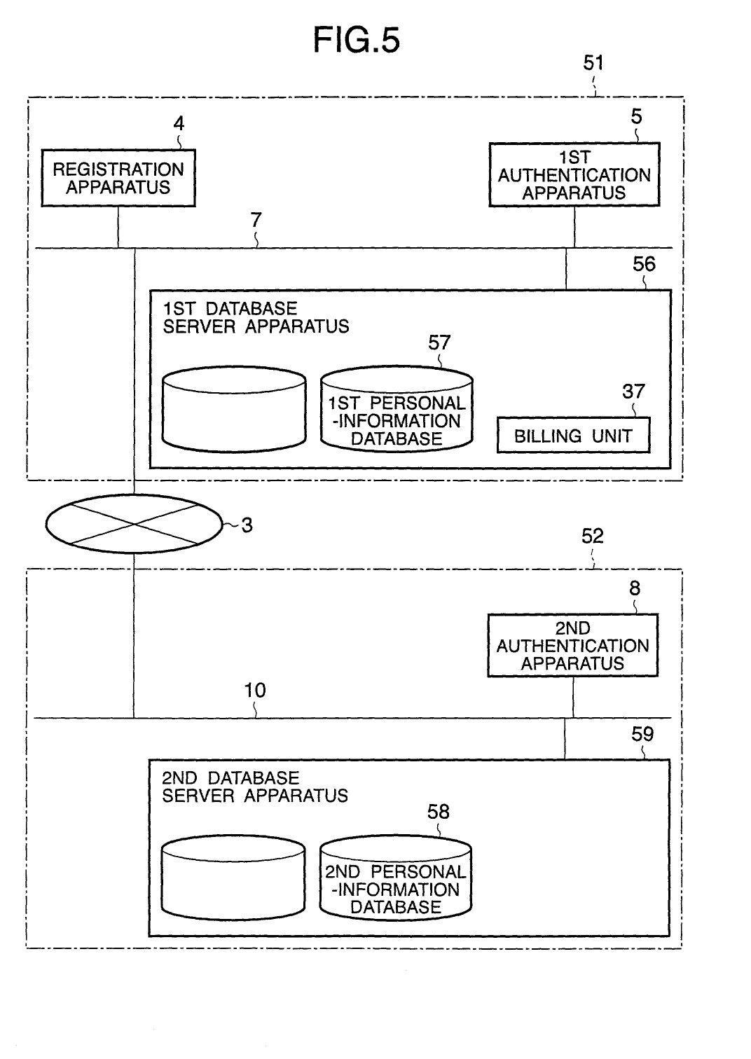

A fifth embodiment has the configuration shown in FIG. 5, comprising a first enterprise system 51 and a second enterprise system 52 interconnected by a communication network 3. The first enterprise system 51 comprises a registration apparatus 4, a first authentication apparatus 5, a first database server apparatus 56, and a first LAN 7. The second enterprise system 52 comprises a second authentication apparatus 8, a second database server apparatus 59, and a second LAN 10.

The first database server apparatus 56 stores and manages template data received from the registration apparatus 4 in an internal dictionary. During authentication, the first database server apparatus 56 compares authentication data received from the first authentication apparatus 5 with the template data to authenticate the user. The first database server apparatus 56 also has a first personal-information database 57 that stores personal information about the user, such as the user's date of birth, address, scholastic record, occupation, income, and so forth.

The second database server apparatus 59 compares authentication data received from the second authentication apparatus 8 with template data received from the first database server apparatus 56 to authenticate a user, and stores the template data in its own internal dictionary if authentication succeeds. The second database server apparatus 59 also has a second personal-information database 58 that stores personal information about the user, such as the user's date of birth, address, scholastic record, occupation, income, and so on, this information being received from the first database server apparatus 56.

The other elements of the fifth embodiment are identical to the corresponding elements of the first embodiment.

The fifth embodiment operates as described in the first embodiment, but also accumulates non-biometric information about users in the personal-information data bases 57, 58. This information can be employed to provide services other than simple authentication.

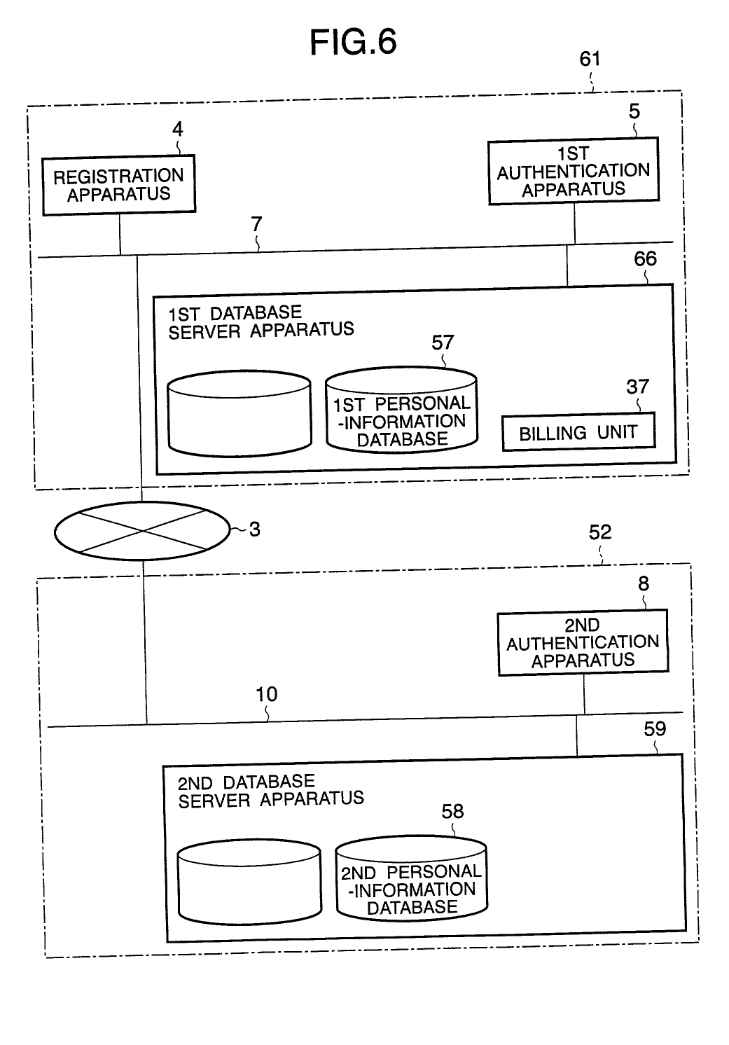

A sixth embodiment has the configuration shown in FIG. 6, comprising a first enterprise system 61 and a second enterprise system 52 interconnected by a communication network 3. The first enterprise system 61 comprises a registration apparatus 4, a first authentication apparatus 5, a first database server apparatus 66, and a first LAN 7. The second enterprise system 52 comprises a second authentication apparatus 8, a second database server apparatus 59, and a second LAN 10.

The first database server apparatus 66 stores and manages template data received from the registration apparatus 4 in an internal dictionary. During authentication, the first database server apparatus 56 compares authentication data received from the first authentication apparatus 5 with the template data to authenticate the user. The first database server apparatus 66 also has a billing unit 37 and a first personal-information database 57. The first personal-information database 57 stores personal information about the user, such as the user's date of birth, address, scholastic record, occupation, income, and so on. When the first database server apparatus 66 is sent identifying information from the second database server apparatus 59 and is requested to send back corresponding template data, the billing unit 37 charges the second enterprise system 52 a fee for this service.

The second database server apparatus 59 compares authentication data received from the second authentication apparatus 8 with template data received from the first database server apparatus 56 to authenticate a user, and stores the template data in its own internal dictionary if authentication succeeds. The second database server apparatus 59 also has a second personal-information database 58 that stores personal information about the user, such as the user's date of birth, address, scholastic record, occupation, income, and so on, this information being received from the first database server apparatus 56.

The other elements of the sixth embodiment are identical to the corresponding elements of the first embodiment.

The sixth embodiment operates as described in the third and fifth embodiments, accumulating personal information in addition to biometric information, enabling the first enterprise to bill the second enterprise for the service of providing biometric information and personal information to the second enterprise, and enabling the first and second enterprise systems to provide services other than simple authentication.

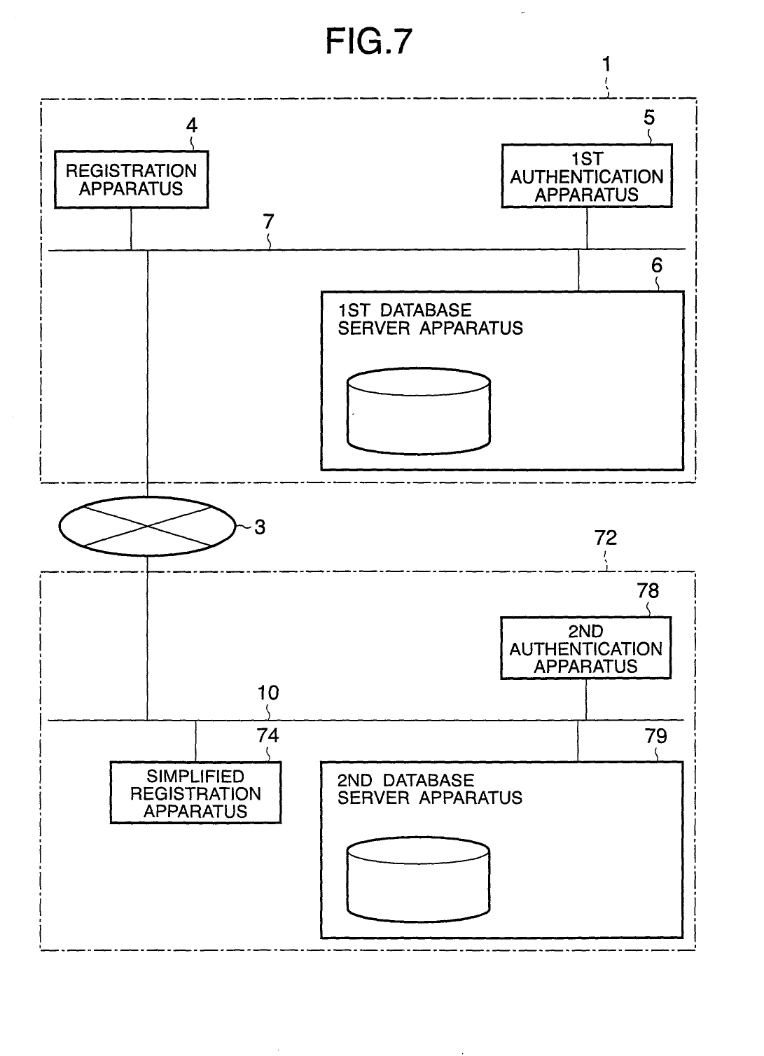

A seventh embodiment has the configuration shown in FIG. 7, comprising a first enterprise system 1 and a second enterprise system 72 interconnected by a communication network 3. The first enterprise system 1 comprises a registration apparatus 4, a first authentication apparatus 5, a first database server apparatus 6, and a first LAN 7. The second enterprise system 72 comprises a second authentication apparatus 78, a simplified registration apparatus 74, a second database server apparatus 79, and a second LAN 10.

The simplified registration apparatus 74 is installed at a location at which new users are registered with the second enterprise system 72, and is connected to the second LAN 10. The simplified registration apparatus 74 acquires a new user's biometric information, extracts features therefrom, and converts the features to authentication data, performing these operations during registration. The simplified registration apparatus 74 has facilities such as a keyboard or magnetic card reader, for entry of identifying information.

The second authentication apparatus 78 acquires a user's biometric information, extracts features therefrom, and converts the features to authentication data, performing these operations during authentication. The second authentication apparatus 8 also has facilities such as a keyboard or magnetic card reader, by which the user enters identifying information.

The second database server apparatus 79 receives authentication data and identifying information from the simplified registration apparatus 74 and second authentication apparatus 78, sends authentication data and identifying information received from the simplified registration apparatus 74 to the first database server 6, receives corresponding template data from the first database server apparatus 6, stores the template data in an internal dictionary (not visible), and compares authentication data received from the second authentication apparatus 78 with the stored template data to authenticate the user.

The other elements of the seventh embodiment are identical to the corresponding elements of the first embodiment, except for differences in the operation of the first database server 6, as described below.

The operation of the seventh embodiment will be described under the same assumptions as in the first embodiment, namely that banks A and B use the biometric authentication system to authenticate ATM users, bank A operating the first enterprise system 1 and bank B operating the second enterprise system 72.

When a user opens an account at bank A or uses an ATM operated by bank A, the seventh embodiment operates in the same way as the first embodiment.

When a user who already has an account at bank A opens an account at bank B, after the user's identity has been checked by personnel at bank B, the simplified registration apparatus 74 is used to acquire the user's iris pattern, generate authentication data, and receive information, from a magnetic card, for example, identifying the user as a user of bank A. The second database server apparatus 79 sends the authentication data and identifying information to the first database server 6 at bank A. The first database server 6 uses the identifying information to retrieve the user's template data from its internal dictionary, and compares the retrieved template data with the received authentication data to authenticate the user's identity. If authentication succeeds, the first database server 6 sends the retrieved template data to the second database server apparatus 79, which stores the template data in its internal dictionary. The user also fills out the usual forms for opening an account at bank B.

The same procedure may of course be used to enable a user who already has an account at bank B to register with the second enterprise system 72, so that the user can use bank B's ATM facilities.

After this procedure, when the user uses an ATM operated by bank B, the second authentication apparatus 78 acquires the user's iris pattern and identifying information and generates authentication data, and the second database server apparatus 79 compares the authentication data with the stored template data to authenticate the user.

Compared with the first embodiment, the seventh embodiment protects users' privacy more thoroughly, because the first database server apparatus 6 sends a user's template data to the second database server apparatus 79 only after authenticating the user itself. Compared with the prior art, the seventh embodiment simplifies the registration procedure at the second enterprise system 72, because there is no need to generate template data, and no highly trained operator is needed to operate the simplified registration apparatus 74.

The seventh embodiment can be modified in any of the ways described in the second to sixth embodiments. That is, the first database server apparatus may be equipped with a one-to-many biometric identification unit, a billing unit, and/or a first personal information database, and the second database server apparatus may include a second personal information database.

The invention is not limited to use by banks to authenticate users of ATMs. The invention can be used by enterprises or organizations of any type that might want to share biometric template data, so that the work of acquiring the data has to be performed only once.

Those skilled in the art will recognize that further variations are possible within the scope claimed below.

What is claimed is:

1. A biometric authentication system comprising a first enterprise system, a second enterprise system, and a communication network interconnecting the first enterprise system and the second enterprise system, wherein:
the first enterprise system includes
a registration apparatus for acquiring a user's biometric information in advance of authentication, extracting features therefrom, and converting the features to template data,
a first authentication apparatus for acquiring the user's biometric information during authentication, extracting features therefrom, and converting the features to authentication data, and
a first database server apparatus for receiving the template data from the registration apparatus, storing and managing the template data, receiving the authentication data from the first authentication apparatus during authentication, comparing the authentication data with the template data, and thereby authenticating the user;
and the second enterprise system includes
a second authentication apparatus for acquiring the user's biometric information, extracting features therefrom, and converting the features to authentication data, and
a second database server apparatus for receiving the authentication data from the second authentication apparatus, requesting corresponding template data from the first database server apparatus, receiving the corresponding template data from the first database server apparatus, comparing the authentication data with the corresponding template data, thereby authenticating the user, and storing and managing the template data if the user is authenticated successfully.

2. The biometric authentication system of claim 1, wherein the second database server apparatus sends the authentication data received from the second authentication apparatus to the first database server apparatus, and the first database server apparatus includes a one-to-many biometric identification unit that performs a one-to-many comparison between the authentication data received from the second database server apparatus and all of the template data stored and managed by the first database server apparatus to find the template data corresponding to the authentication data.

3. The biometric authentication system of claim 1, wherein the first database server apparatus includes a billing unit that charges the second enterprise system a fee when the second database server apparatus requests corresponding template data and the first database server apparatus sends the corresponding template data to the second database server apparatus.

4. The biometric authentication system of claim 3, wherein the second database server apparatus sends the authentication data received from the second authentication apparatus to the first database server apparatus when requesting the corresponding template data, and the first database server apparatus includes a one-to-many biometric identification unit that performs a one-to-many comparison between the authentication data received from the second database server apparatus and all of the template data stored and managed by the first database server apparatus to find the template data corresponding to the authentication data.

5. The biometric authentication system of claim 1, wherein:
the first database server apparatus includes a first personal-information database storing personal information about the user;
when the first database server apparatus sends the corresponding template data to the second database server apparatus, the first database server apparatus also sends the personal information about the user to the second database server apparatus; and
the second database server apparatus includes a second personal-information database that stores and manages the personal information about the user received from the first database server apparatus.

6. The biometric authentication system of claim 5, wherein the first database server apparatus includes a billing unit that charges the second enterprise system a fee when the first database server apparatus sends the corresponding template data and the personal information about the user to the second database server apparatus.

7. A biometric authentication system comprising a first enterprise system, a second enterprise system, and a communication network interconnecting the first enterprise system and the second enterprise system, wherein:
the first enterprise system includes
a registration apparatus for acquiring a user's biometric information in advance of authentication, extracting features therefrom, and converting the features to template data,
a first authentication apparatus for acquiring the user's biometric information during authentication, extracting features therefrom, and converting the features to authentication data, and
a first database server apparatus for receiving the template data from the registration apparatus, storing and managing the template data, receiving the authentication data from the first authentication apparatus during authentication, comparing the authentication data with the template data, thereby authenticating the user, receiving authentication data from the second enterprise system, and returning corresponding template data to the second enterprise system if the corresponding template data is stored in the first database server apparatus;
and the second enterprise system includes
a simplified registration apparatus for acquiring the user's biometric information during registration, extracting features therefrom, and converting the features to authentication data;
a second authentication apparatus for acquiring the user's biometric information during authentication, extracting features therefrom, and converting the features to authentication data, and
a second database server apparatus for receiving the authentication data from the simplified registration apparatus and the second authentication apparatus, sending the authentication data received from the simplified registration apparatus to the first database server apparatus, receiving the corresponding template data from the first database server apparatus, storing and managing the received template data, and comparing the authentication data received from the second authentication apparatus with the stored template data, thereby authenticating the user.

8. A database server apparatus for use in a first enterprise system that is linked by a communication network to a second enterprise system, for receiving biometric template data and biometric authentication data from the first enterprise system, storing and managing the biometric template data, comparing the biometric authentication data with the biometric template data, thereby authenticating users of the first enterprise system, and supplying the biometric template data on request to the second enterprise system to enable users of the first enterprise system to become registered with the second enterprise system.

9. The database server apparatus of claim 8, comprising a one-to-many biometric identification unit that performs a one-to-many comparison between biometric authentication data received from the second enterprise system and the biometric template data stored and managed by the first database server apparatus to find the biometric template data requested by the second enterprise system.

10. The database server apparatus of claim 8, comprising a billing unit that charges the second enterprise system a fee when the database server apparatus sends the biometric template data to the second enterprise system.

11. The database server apparatus of claim 8, comprising a personal-information database storing personal information about the users of the first enterprise system, the personal information being sent to the second enterprise system together with the biometric template data requested by the second enterprise system.

12. The database server apparatus of claim 8, wherein the database server apparatus receives biometric authentication data from the second enterprise system, compares the received biometric authentication data with the requested biometric template data, and sends the requested biometric template data to the second enterprise system only if the received biometric authentication data match the requested biometric template data.

13. A database server apparatus for use in a second enterprise system that is linked by a communication network to a first enterprise system, for receiving biometric authentication data from the second enterprise system, requesting corresponding biometric template data from the first enterprise system, receiving the requested biometric template data from the first enterprise system, storing and managing the received biometric template data, and comparing the biometric authentication data with the stored biometric template data, thereby authenticating users of the second enterprise system.

14. The database server apparatus of claim 13, wherein the database server apparatus sends the biometric authentication data received from the second enterprise system to the first enterprise system when requesting the corresponding biometric template data from the first enterprise system.

15. The database server apparatus of claim 13, comprising a personal-information database for storing personal information about the users of the second enterprise system, the personal information being received from the first enterprise system together with the requested biometric template data.
